(19) United States
(12) Patent Application Publication
(10) Pub. No.: US 2012/0142573 A1
(43) Pub. Date: Jun. 7, 2012

(54) USE OF MIXTURES FOR REMOVING POLYURETHANE FROM METAL SURFACES

(75) Inventors: Sabrina Montero Pancera, Viernheim (DE); Berthold Ferstl, Bensheim (DE); Jürhen Prüfe, Schwetzingen (DE); Marco Ross, Ludwigshafen (DE)

(73) Assignee: BASF SE, Ludwigshafen (DE)

(21) Appl. No.: 13/307,497

(22) Filed: Nov. 30, 2011

Related U.S. Application Data
(60) Provisional application No. 61/418,894, filed on Dec. 2, 2010.

(51) Int. Cl. C09D 9/04

(52) U.S. Cl. 510/202

(57) ABSTRACT

Use of mixtures comprising

(A) at least one solvent with a flashpoint of at least 80° C.,

(B) at least one corrosion inhibitor which is liquid at room temperature,

(C) at least one base selected from organic amines, ammonium hydroxides, and alkali metal hydroxides,

(D) water, and

(E) optionally one or more polyurethanes, for removing polyurethane from metal surfaces.

The present invention relates to the use of mixtures comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes, for removing polyurethane from metal surfaces.

The present invention further relates to a process for removing polyurethanes from metal surfaces, with use of a mixture comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes.

The present invention further relates to mixtures with which the process of the invention can be implemented with particular success.

Polyurethanes are versatile materials and are therefore in high demand. By way of example, they can be processed to give dispersions, foams, and films, and they can also be processed as thermoplastics. Many polyurethanes are chemically and mechanically stable over long periods. They can moreover be processed to give very complicated moldings and films with patterning. There are therefore numerous molds which can be used to process polyurethanes with a very wide variety of constitutions.

However, removal of polyurethane residues from molds remains a challenge. This challenge is always particularly evident when the intention is to clean metal surfaces from which patterning is to be transferred to the polyurethane and the pattern has very small elements, for example patterning in the pm range. Even small amounts of residual polyurethane remaining in the mold can have a considerable adverse effect on the appearance of the product subsequently produced. Complete removal of the polyurethane residues is therefore of interest. Solvent or solvent mixtures can be used for this purpose. On the one hand, a certain strength is desirable from the solvent here. On the other hand, there should be no damage to the metal surface, for example of the mold.

The structures of polyurethanes can differ greatly, both chemically and morphologically. WO 2006/056298 discloses certain mixtures and their use for removing resist residues from copper surfaces in semiconductor arrangements. These resist residues involve inorganic, organic, or organometallic plasma-generated substances which are preferably polymerizable by a free-radical route or have undergone complete polymerization by a free-radical route and which by way of example are retained when holes are burnt in semiconductors.

An object was to provide a mixture with which polyurethane can be removed from metal surfaces without damage to these. Another object was to provide a process for removing polyurethane from metal surfaces.

Accordingly, the use defined in the introduction has been discovered for mixtures.

Mixtures used in the invention comprise:
(A) at least one solvent with a flashpoint of at least 80° C., also termed solvent (A) for the purposes of the present invention, preferably dimethyl sulfoxide (DMSO),
(B) at least one corrosion inhibitor, also termed corrosion inhibitor (B) for the purposes of the present invention,
(C) at least one base selected from organic amines, ammonium hydroxides, and alkali metal hydroxides, also termed base (C) for the purposes of the present invention,
(D) water, and
(E) optionally one or more polyurethanes, also termed polyurethane (E) for the purposes of the present invention.

Solvent (A) is an organic solvent which is liquid at room temperature, and solvent (A) differs from corrosion inhibitor (B) and from base (C).

Solvent (A) has a flashpoint of at least 80° C., preferably at least 85° C., which can be determined in a closed crucible, for example by the Pensky-Martens method, DIN 51758, EN 22719, or to ASTM D 93.

Solvent (A) preferably involves a solvent which has no hydroxy groups. It is particularly preferable that solvent (A) involves DMSO. It is very particularly preferable that solvent (A) involves DMSO with metal ion content in the range from zero to 100 ppm (parts per million, based on proportions by weight).

Corrosion inhibitor (B) is selected from substances which are different from solvent (A) and from base (C) and which can retard or prevent the corrosion of metals, for example steel or nickel. Particular examples are substances which can passivate metal surfaces or which, through deposition on metal surfaces, can retard or prevent an oxidation reaction.

Examples of corrosion inhibitors that are solid at room temperature are benzotriazole, and sugars and sugar alcohols, for example mannitol and sorbitol.

It is preferable that corrosion inhibitor (B) is liquid at room temperature.

Preferred corrosion inhibitors (B) which are liquid at room temperature are those selected from diols, triols, and tetraols. For the purposes of the present invention, diols here are aliphatic compounds having two hydroxy groups per molecule. For the purposes of the present invention, triols are compounds having three hydroxy groups per molecule. Tetraols are accordingly compounds having four hydroxy groups per molecule.

Examples of corrosion inhibitors (B) are ethylene glycol, propylene glycol, diethylene glycol, dipropylene glycol, triethylene glycol, tripropylene glycol, polyethylene glycol, for example with average molar mass Mn in the range from 175 to 25 000 g/mol, preferably up to 10 000 g/mol, polypropylene glycol, for example with average molar mass Mn in the range from 250 to 4000 g/mol, preferably up to 2500 g/mol, and also 2,2-dimethylpropane-1,3-diol and 2-ethyl-2-hydroxymethylpropane-1,3-diol.

Examples of triols preferred as corrosion inhibitors (B) are 1,2,4-butanetriol and in particular glycerol, and an example of tetraols preferred as corrosion inhibitors (B) is pentaerythritol.

Base (C) is selected from organic amines, ammonium hydroxides, and alkali metal hydroxides. Examples of organic amines are in particular low-odor amines, for example tertiary aliphatic amines having at least 14 carbon atoms per molecule, e.g. N,N-dimethylstearylamine. Preferred organic amines are mono-, bis- and trihydroxyalkylamines, e.g. ethanolamine, N,N-diethanolamine, N-methylethanolamine, N,N-dimethylethanolamine, N-n-butylethanolamine, and triethanolamine.

For the purposes of the present invention, the expression ammonium hydroxides covers basic compounds produced in aqueous solution via protonation of ammonia or of organic amines. Preferred ammonium hydroxides are quaternary ammonium hydroxides, in particular tetra-C₁-C₄-alkylammmonium hydroxides, where the C₁-C₄-alkyl moieties can be different or preferably identical. Preferred ammonium hydroxides are tetraethylammonium hydroxide and in particular tetramethylammonium hydroxide (abbreviated to TMA).

Other suitable bases (C) are those selected from alkali metal hydroxides, in particular sodium hydroxide and potassium hydroxide.

Mixtures used in the invention also comprise water (D). Water (D) can involve water which has not been pretreated, or preferably water which has been distilled and demineralized via other methods known per se, for example water demineralized via use of an ion exchanger.

In one embodiment of the present invention, mixtures used in the invention comprise: from 80 to 95% by weight, preferably from 87 to 92% by weight, of solvent (A), from 0.5 to 4% by weight, preferably from 1.5 to 2.5% by weight, of corrosion inhibitor (B), from 1 to 6% by weight, preferably from 2 to 4% by weight, of base (C), and from 3 to 12% by weight, preferably from 5 to 10% by weight, of water (D), where data in % by weight are always based on an entire mixture.

Mixtures used in the invention can also comprise one or more polyurethanes (E). Polyurethanes (E) can involve aliphatic or aromatic polyurethanes, polyether urethanes, or polyester urethanes, or polyurethanes produced via a polyaddition reaction using at least one diisocyanate and at least one low-molecular-weight diol, or using at least one compound which has at least two groups which are capable of reaction with isocyanate and which can be different or identical, in particular NH₂, OH, SH, and COOH.

In one embodiment of the present invention, a mixture used in the invention comprises from 0 to 30% by weight of polyurethane (E), based on the entirety of the following components: solvent (A), corrosion inhibitor (B), base (C), and water (D).

Mixtures used in the invention can be produced via mixing of the following components: solvent (A), corrosion inhibitor (B), base (C), and water (D), where the sequence of addition of the following components during the mixing process is not critical: solvent (A), corrosion inhibitor (B), base (C), and water (D). However, if alkali metal hydroxide or ammonium hydroxide is intended for use as base (C) it is preferable to begin by mixing base (C) with water (D).

It is not necessary to add polyurethane (E) to the inventive mixture used. Mixtures comprising the following components: solvent (A), corrosion inhibitor (B), base (C), and water (D) can be used repeatedly for removing polyurethane from metal surfaces without any requirement to extract the polyurethane removed. Polyurethane removed then remains—with any additives present—in the mixture used in the invention.

Mixtures described above are used in the invention for removing polyurethane from metal surfaces, in particular for removing polyurethanes which are selected from residues of foams and residues of films. By way of example, polyurethane to be removed can have thermoplastic properties. Polyurethane to be removed can be crosslinked or uncrosslinked polyurethane.

Polyurethane to be removed can by way of example be in pure form or can comprise additives. For the purposes of the present invention, in the context of the polyurethane to be removed in the invention, the expression “comprise additives” means that polyurethane can comprise one or more additives, for example UV stabilizers, fillers, matting agents, pigments, adhesion promoters, or haptic improvers. By way of example, silicones can be present for haptic improvement in polyurethane to be removed. Examples of fillers that may be mentioned are: SiO₂, Al₂O₃, and phyllosilicates. Particular examples of important pigments are iron oxide pigments.

Examples of metal surfaces that can be used are steel surfaces, nickel surfaces, aluminum surfaces, and surfaces of nickel alloys, including nickel alloys which are not steels. For the purposes of the present invention, metal surfaces can be brushed surfaces, and can be smooth or patterned, for example with grooves, they can be non-passivated or passivated surfaces.

In one specific embodiment, metal surfaces can have etched grain effects. The expression “etched grain effects” here means metal surfaces which were smooth after they had been produced and which have been altered through exposure to acids or to other substances which attack the metal, the result being defined desired, full-surface grain structures, where the grain structures of these surfaces are intended to be retained because by way of example they are part of an embossing ram or of a mold for injection molding.

Metal surfaces can have regular or irregular shape. They can be flat or curved, for example convex or concave. Metal surfaces can involve one surface or—in the case of the internal surface of a pot or tank—a combination of various geometric arrangements of surfaces.

The present invention further provides a process for removing polyurethane from metal surfaces, also abbreviated to process of the invention. The process of the invention comprises using a mixture comprising
(A) at least one solvent with a flashpoint of at least 80° C.,
(B) at least one corrosion inhibitor which is liquid at room temperature,
(C) at least one base selected from organic amines, ammonium hydroxides, and alkali metal hydroxides,
(D) water, and
(E) optionally one or more polyurethanes.

Conduct of the process of the invention starts from a metal surface contaminated with polyurethane, where polyurethane present as contaminant has been defined above. Metal surfaces are preferably selected from steel surfaces, aluminum surfaces, nickel surfaces, and surfaces of nickel alloys.

By way of example, metal surfaces can concern the internal side of mixing vessels or of mixing tanks, or the internal side of pipes.

By way of example, metal surfaces can concern an external side, or preferably the internal side, of molds, for example embossing rams, extruders, or preferably molds for injection molding machines.

Polyurethane present as contaminant can by way of example take the form of thin film, for example with a thickness in the range from 1 μm to 300 μm, on the metal surface, and specifically on the entire surface or only at some locations. In one variant, polyurethane present as contaminant can be present on the metal surface only in some locations which are difficult to reach by mechanical means, for example in grooves or in edges, corners, or angles, in particular in grooves and undercuts, where these cannot be reached by mechanical means.

A description has been provided above of the following: metal surfaces, polyurethane to be removed, mixtures used, and the following components: solvent (A), corrosion inhibitor (B), base (C), and water (D), and also polyurethane (E) optionally present.

There are various methods of conducting the process of the invention. By way of example, a mixture of the invention can be used to spray and/or wipe a metal surface contaminated with polyurethane.

However, in a preferred procedure, an article which has at least one metal surface contaminated with polyurethane and the temperature of which is in the range from 40 to 90° C. is dipped into a mixture comprising
(A) at least one solvent with a flashpoint of at least 80° C.,
(B) at least one corrosion inhibitor which is liquid at room temperature,
(C) at least one base selected from organic amines, ammonium hydroxides, and alkali metal hydroxides,
(D) water, and
(E) optionally one or more polyurethanes, and is then dried.

In one variant, the article, which has at least one metal surface is dipped into the mixture described above for a period of from 5 minutes up to 12 hours.

During the immersion process, the mixture can be set in motion, for example via shaking or stirring. In another variant, the article having a surface contaminated with polyurethane is flushed with mixture used in the invention, if possible with the aid of a pump. In one variant, the article having a surface contaminated with polyurethane is flushed with mixture used in the invention, if possible in circulation. In another variant, the article having at least one metal surface contaminated with polyurethane is allowed to stand or lie in the mixture, and the mixture is not set in motion.

Prior to the drying process, one or more rinses may be implemented, for example using water, preferably using demineralized water.

The drying process can by way of example be conducted at reduced pressure, and accelerated by an air current, for example by use of a fan, or by heating, or by a combination of at least two of the abovementioned measures.

The process of the invention is a simple method of obtaining metal surfaces that have been very successfully cleaned. The mixture used can be used repeatedly, and content of polyurethane (E) does not, or does not significantly, reduce effectiveness.

The present invention further provides a mixture comprising
(A) at least one solvent with a flashpoint of at least 80° C., preferably DMSO,
(B) at least one corrosion inhibitor which is liquid at room temperature,
(C) at least one base selected from organic amines, ammonium hydroxides, and alkali metal hydroxides,
(D) water, and
(E) one or more polyurethanes.

A description has been provided above of the following components: solvent (A), corrosion inhibitor (B), base (C), and water (D), and also polyurethane (E).

In one embodiment, a mixture of the invention comprises from 80 to 95% by weight, preferably from 87 to 92% by weight, of solvent (A), from 0.5 to 4% by weight, preferably from 1.5 to 2.5% by weight, of corrosion inhibitor (B), from 1 to 6% by weight, preferably from 2 to 4% by weight, of base (C), and from 3 to 12% by weight, preferably from 5 to 10% by weight, of water (D), where data in % by weight are always based on the sum of the proportions of solvent (A), corrosion inhibitor (B), base (C), and water (D).

In one embodiment of the present invention, a mixture of the invention comprises from 0.1 to 30% by weight of polyurethane (E), based on the entirety of solvent (A), corrosion inhibitor (B), base (C), and water (ID).

In one embodiment of the present invention, a mixture of the invention comprises one or more additives for polyurethanes, for example UV stabilizers, fillers, matting agents, pigments, or haptic improvers. A description has been provided above of examples of additives for polyurethanes.

A mixture of the invention can be used once or repeatedly for removing polyurethane from metal surfaces.

Working examples are used to illustrate the invention.

For the purposes of the present invention, data in % and in ppm are always based on % by weight and, respectively, ppm by weight, unless expressly otherwise stated. Metal surfaces were checked for absence of contamination by visual inspection under an optical microscope and by using test inks (Arcotest), e.g. from Arcotest, Monsheim to measure the surface tension of the cleaned metal surface.

Production of mixtures:

A mixture was provided by mixing

90 kg of DMSO, metal ion content below 100 ppm,

2 kg of ethylene glycol, and

2 kg of tetramethylammonium hydroxide, dissolved in 6 kg of water.

The following were checked as metal ions in the DMSO: Al³⁺, Na⁺, Ca²⁺, Mg²⁺, K⁺, Fe²⁺/Fe³⁺, and Zn²⁺. In all cases, content was below 10 ppm.

This gave mixture 1.

### EXAMPLE 1

A nickel-coated steel plaque measuring 4.4 cm, partially provided with a grain pattern and contaminated with an aliphatic polyurethane in the form of a thin film (in the range from 30 to 300 μm) and with polyurethane particles was immersed at 80° C. in mixture 1 and left for 12 hours therein, with occasional movement. The nickel-coated steel plaque was then removed and rinsed with water. It was then dried in a drying oven (80° C.).

The surface of the nickel-coated steel plaque was completely free from contamination and exhibited no corrosion damage of any kind.

### EXAMPLE 2

Mixture 1 was heated to 80° C. after conduct of Example 1.

A nickel-coated steel plaque measuring 4.4 cm, partially provided with a grain pattern, and contaminated with an aliphatic polyurethane in the form of a thin film (in the range from 30 to 300 μm) and with polyurethane particles was immersed at room temperature into mixture 1 which had been heated to 80° C. (after conduct of Example 1), and left for 12 hours therein, with occasional movement. The steel plaque was then removed and rinsed with water. It was then dried in a drying oven (80° C.).

The surface of the steel plaque was completely free from contamination and exhibited no corrosion damage of any kind.

1. The use of mixtures comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes, for removing polyurethane from metal surfaces.

2. The use according to claim 1, wherein metal surfaces involve steel surfaces, aluminum surfaces, nickel surfaces, or surfaces of nickel alloys.

3. The use according to claim 1 or 2, wherein corrosion inhibitor (B) is liquid at room temperature.

4. The use according to any of claims 1 to 3, wherein corrosion inhibitor (B) is selected from ethylene glycol, propylene glycol, diethylene glycol, dipropylene glycol, triethylene glycol, tripropylene glycol, polyethylene glycol, polypropylene glycol, glycerol, 2,2-dimethylpropane-1,3-diol and 2-ethyl-2-hydroxymethylpropane-1,3-diol.

5. The use according to any of claims 1 to 4, wherein solvent (A) involves dimethyl sulfoxide (DMSO).

6. The use according to any of claims 1 to 5, wherein polyurethane involves residues of films or of foams.

7. The use according to any of claims 1 to 6, wherein polyurethane can comprise one or more additives selected from haptic improvers, fillers, color pigments, and matting agents.

8. The use according to any of claims 1 to 7, wherein base (C) selected comprises at least one tetra-C₁-C₄-alkylammonium hydroxide, where each C₁-C₄-alkyl can be different or identical.

9. The use according to any of claims 1 to 8, wherein base (C) selected comprises tetramethylammonium hydroxide or tetraethylammonium hydroxide.

10. The use according to any of claims 1 to 9, wherein the mixture comprises:
from 80 to 95% by weight of solvent (A),
from 0.5 to 4% by weight of corrosion inhibitor (B),
from 1 to 6% by weight of base (C), and
from 3 to 12% by weight of water (D),
where data in % by weight are always based on an entire mixture.

11. A process for removing polyurethanes from metal surfaces, which comprises using a mixture comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes.

12. The process according to claim 11, wherein metal surfaces involve steel surfaces, aluminum surfaces, nickel surfaces, or surfaces of nickel alloys.

13. The process according to claim 11 or 12, wherein corrosion inhibitor (B) is liquid at room temperature.

14. The process according to any of claims 11 to 13, wherein an article which has at least one metal surface and the temperature of which is in the range from 40 to 90° C. is dipped into a mixture comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes, and is then dried.

15. The process according to any of claims 11 to 14, wherein the mixture is repeatedly reused.

16. A mixture comprising
(A) at least one solvent with a flashpoint of at least 80° C.,
(B) at least one corrosion inhibitor,
(C) at least one base selected from organic amines, ammonium hydroxides, and alkali metal hydroxides,
(D) water, and
(E) optionally one or more polyurethanes.
